(19) United States
(12) Patent Application Publication
(10) Pub. No.: US 2025/0258312 A1
(43) Pub. Date: Aug. 14, 2025

(54) Fracture Determination Ahead Of The Tool Using Electromagnetic Signal Gradient Variation

(71) Applicant: Halliburton Energy Services, Inc., Houston, TX (US)

(72) Inventors: Hsu-Hsiang Wu, Houston, TX (US); Jin Ma, Houston, TX (US); Yi Jing Fan, Singapore (SG)

(73) Assignee: Halliburton Energy Services, Inc., Houston, TX (US)

(21) Appl. No.: 18/440,749

(22) Filed: Feb. 13, 2024

(51) Int. Cl. G01V 3/30

(52) U.S. Cl. CPC G01V 3/30

(57) ABSTRACT

A method for identifying resistivity variations in a formation. The method may include inserting an electromagnetic tool into a wellbore. The method may further include transmitting an electromagnetic wave into the subterranean formation with the transmitter coil at a first depth and receiving a first collection of one or more response signals with the first receiver coil at the first depth. The method may further include moving the electromagnetic tool to a second depth within the wellbore and repeating the process, forming a plurality of geological models based at least in part on the first and second collection of one or more responses signals, inverting each of the plurality of geological models to form a solution for each of the plurality of geological models, and comparing each of the solutions for the first depth and the second depth to identify one or more resistivity variations within the subterranean formation.

### BACKGROUND

Modern petroleum drilling and production operations may demand a great quantity of information relating to the parameters and conditions downhole. Such information typically includes the location and orientation of the borehole and drilling assembly, earth formation properties, and parameters of the downhole drilling environment. The collection of information relating to formation properties and downhole conditions is commonly referred to as logging and can be performed during the drilling process itself (hence the term “logging while drilling” or “LWD,” frequently used interchangeably with the term “measurement while drilling” or “MWD”).

When plotted as a function of depth or tool position in the borehole, the logging tool measurements are termed “logs.” Resistivity logging may be used in well logging to determine geological correlation of formation strata and detect and quantify potentially productive formation zones. Such logs may provide indications of hydrocarbon concentrations and other information useful to drillers and completion engineers. In particular, azimuthally-sensitive logs may provide information useful for steering the drilling assembly because they can inform the driller when a target formation bed has been entered or exited, thereby enabling modifications to the drilling program that will provide much more value and higher success than would be the case using only seismic data.

During drilling operations used for the exploration of hydrocarbons, it may be desirable to detect and circumnavigate fractures located in the subterranean formation. Subterranean fractures may be naturally occurring or man-made. For example, natural faults, fractures, and fissures may form in the subterranean formation as a natural response to subterranean stress, while hydraulic fracturing (e.g., hydraulic fracturing operations used by the energy industry to improve hydrocarbon production) may create man-made fracture networks in the subterranean formation. It may be desirable to avoid transecting subterranean fractures with a wellbore for production optimization, safety, and operational optimization purposes.

### BRIEF DESCRIPTION OF THE DRAWINGS

The features and advantages of certain embodiments will be more readily appreciated when considered in conjunction with the accompanying figures. The figures are not to be construed as limiting any of the preferred embodiments.

FIG. 1 shows an illustrative logging while drilling (LWD) environment.

FIG. 2 shows an illustrative drill string with two logging tool modules.

FIG. 3 shows an illustrative logging tool and a surface system.

FIG. 4 shows an illustrative logging tool.

FIGS. 5A and 5B shows a tool response in one orientation (e.g., XX or YY) as a function of depth.

FIG. 6 illustrates a schematic of an information handling system.

FIG. 7 illustrates a schematic of a chip set.

FIG. 8 illustrates a computing network.

FIG. 9 illustrates a neural network.

FIGS. 10A-10C illustrate a logging operation at multiple depths within a borehole.

FIG. 11 illustrates a workflow for a many-initial-guess approach, combining a random statistical concept with a deterministic inversion algorithm.

FIGS. 12A and 12B resistivity maps of two wells in a field test.

FIGS. 13A and 13B are graphs showing uncertainty at different depths of the two wells in FIGS. 12A and 12B from the field test.

FIG. 14 is a graph comparing offset log data and vertical resistivity profiles form an inversion.

### DETAILED DESCRIPTION

This disclosure may generally relate to apparatuses, systems and methods for producing deep formation evaluations using logging while drilling (“LWD”) tools with multiple subs. In other examples, this disclosure may relate to apparatuses, systems, and/or methods for producing deep formation evaluations using wireline logging having multiple subs.

Embodiments of the present disclosure relate to systems and techniques for performing and utilizing a knowledge-based inversion with gradient transition profiles between formation layers to detect subterranean fractures ahead of the progression of a wellbore. In some examples, an electromagnetic resistivity tool may be configured to measure various properties of an underground formation (e.g., formation properties) during a drilling operation for the exploration and/or production of hydrocarbon deposits from a reservoir within the formation. In further examples, the formation properties may include aspects related to the subterranean fluids and/or lithology. In further examples, the measurements from an electromagnetic resistivity tool may be utilized to identify natural or man-made fractures in undrilled portions of the subterranean formation ahead of the drill bit. However, it should be noted that embodiments are not intended to be limited thereto and that the disclosed embodiments may be applied to other types of measurement tools utilized to assess the subterranean formation (e.g., acoustic or ultrasonic tools). Further, it should be noted that such tools may be used to measure other types of formation properties, e.g., permeability, permittivity, etc.

Generally, in real formations, a resistivity of the formation varies in different directions, for example, a formation resistivity may vary in the x, y, and z coordinates. In electrically anisotropic formations, the anisotropy may be attributable to extremely fine layering during the sedimentary buildup of the formation. A formation Cartesian coordinate system may be oriented such that the x-y plane is parallel to the formation layers and the z axis is perpendicular to the formation layers. Resistivities measured in the x and y directions (e.g., Rx and Ry, respectively), may tend to be more similar relative to resistivity measured in the x direction (e.g., Rz). The resistivity in a direction parallel to the formation plane (i.e., the x-y plane) may be referred to as the horizontal resistivity, Rh, and the resistivity in the direction perpendicular to the plane of the formation (i.e., the z direction) may be referred to the vertical resistivity, Rv. Due to the geological processes which deposit and form lithified sedimentary depositions, it may be more common to see gradational lithological changes rather than abrupt lithological changes. Likewise, these changes may be reflected in the responses measured from a formation evaluation tool, such as an electromagnetic resistivity tool.

The raw measurements acquired with an electromagnetic resistivity tool (e.g., apparent resistivity) may be challenging to evaluate and/or interpret without the application of an inversion. An inversion may be a mathematical or statistical technique which incorporates forward modeling to recover plausible physical formation properties from raw measurements collected by a formation evaluation tool. Prior knowledge related to the formation in which the measurements were acquired may be incorporated into the forward modelling process in order to place boundaries around the potential interpretations (e.g., solutions) on which the forward model may converge. Additionally, the prior knowledge about the formation may create a range of potential inversion assumptions where any particular assumption in the range of assumptions may be associated with different statistical likelihoods of occurrence. As a result, an inversion may create a multitude of interpretations which may further be ranked according to their statistically likelihood of occurrence. Due to the statistical and iterative nature of an inversion calculation, dramatic departures or abrupt changes in the raw measurements (e.g., inputs to the inversion) collected by a formation evaluation tool (e.g., electromagnetic resistivity tool) may create unstable inversion solutions. While these abrupt changes may corrupt or obfuscate the formation properties in the geospatial vicinity where the data was collected, they may additionally indicate geologic discontinuities such as natural or man-made fractures and faults.

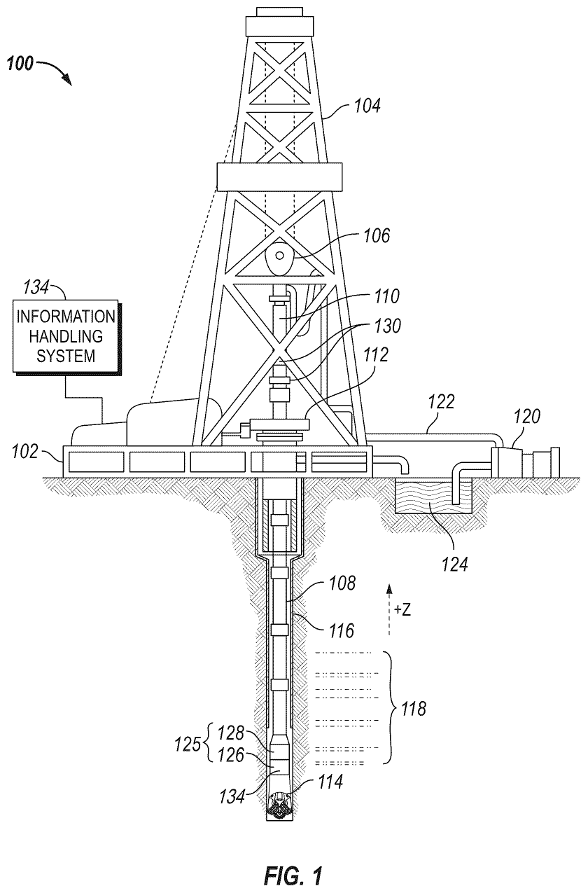

The disclosed apparatuses, systems and methods may be best understood in the context of the larger systems in which they operate. FIG. 1 illustrates a diagrammatic view of an exemplary logging while drilling (LWD) and/or measurement while drilling (MWD) wellbore operating environment 100 in which the present disclosure may be implemented. As depicted in FIG. 1, a drilling platform 102 is equipped with a derrick 104 that supports a hoist 106 for raising and lowering a drill string 108. Hoist 106 suspends a top drive 110 suitable for rotating the drill string 108 and lowering the drill string 108 through the well head 112. Connected to the lower end of the drill string 108 is a drill bit 114. As drill bit 114 rotates, drill bit 114 creates a wellbore 116 that passes through various subterranean formation 118. A pump 120 circulates drilling fluid through a supply pipe 122 to top drive 110, down through the interior of drill string 108, through orifices in drill bit 114, back to the surface via the annulus around drill string 108, and into a retention pit 124. The drilling fluid transports cuttings from the wellbore 116 into retention pit 124 and aids in maintaining the integrity of the wellbore 116. Various materials can be used for drilling fluid, including oil-based fluids and water-based fluids.

As depicted in FIG. 1, logging tools 126 are integrated into the bottom-hole assembly 125 near drill bit 114. As the drill bit 114 extends wellbore 116 through the subterranean formation 118, logging tools 126 collect measurements relating to various formation properties as well as the orientation of the tool and various other drilling conditions. The bottom-hole assembly 125 may also include a telemetry sub 128 to transfer measurement data to a surface receiver 130 and to receive commands from the surface. In some embodiments, the telemetry sub 128 communicates with a surface receiver 130 using mud pulse telemetry. In other cases, the telemetry sub 128 does not communicate with the surface, but rather stores logging data for later retrieval at the surface when the logging assembly is recovered. Notably, one or more of the bottom-hole assembly 125, the logging tools 126, and the telemetry sub 128 may also operate using a non-conductive cable (e.g., slickline, etc.) with a local power supply, such as batteries and the like. When employing non-conductive cable, communication may be supported using, for example, wireless protocols (e.g., EM, acoustic, etc.) and/or measurements and logging data may be stored in local memory for subsequent retrieval at the surface, as is appreciated by those skilled in the art.

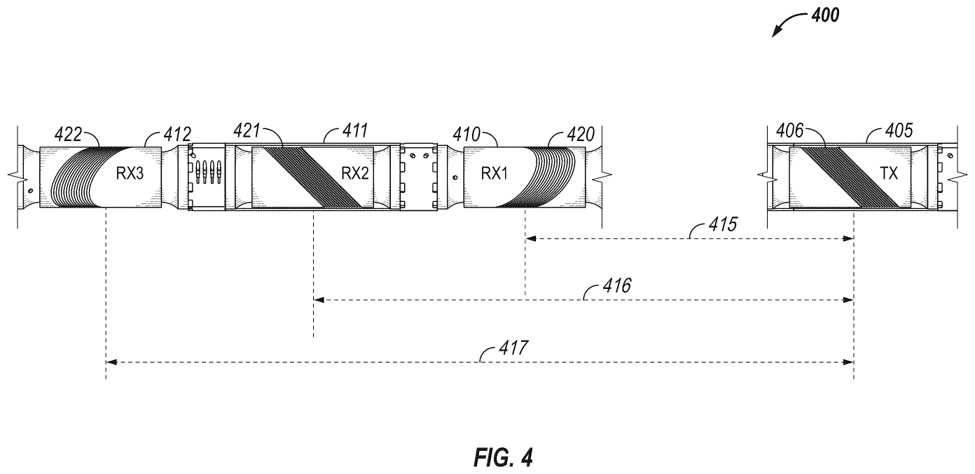

Each of the logging tools 126 may include a plurality of tool components, spaced apart from each other, and communicatively coupled with one or more wires. Logging tools 126 may include tools such as the one shown in FIG. 4 in order to perform resistivity, or conductivity logging. The telemetry sub 128 may include wireless telemetry or logging capabilities, or both, such as to transmit or later provide information indicative of received energy/waveforms to operators on the surface or for later access and data processing for the evaluation of formation 118 properties.

Further, bottom-hole assembly 125 may include a telemetry sub to maintain a communications link with the surface (e.g., with information handling system 134). Such telemetry communications may be used for (i) transferring tool measurement data from bottom-hole assembly (BHA) 125 to surface receivers, and/or (ii) receiving commands (from the surface) to bottom-hole assembly 125 (e.g., for use of one or more tool(s) in bottom-hole assembly 125). In examples, telemetry communications may be at least in part between bottom-hole assembly 125 and information handling system 134. Additionally, information handling system 134 may be disposed at surface and communication with BHA 125 as well as logging tool 126 and/or telemetry sub 128.

As illustrated, the information handling system 134 may comprise any instrumentality or aggregate of instrumentalities operable to compute, estimate, classify, process, transmit, broadcast, receive, retrieve, originate, switch, store, display, manifest, detect, record, reproduce, handle, or utilize any form of information, intelligence, or data for business, scientific, control, or other purposes. For example, an information handling system 134 may be a personal computer, a network storage device, or any other suitable device and may vary in size, shape, performance, functionality, and price.

Information handling system 134 may include a processing unit (e.g., microprocessor, central processing unit, etc.) that may process drilling data from rotary steerable system (RSS) which may be disposed on bottom-hole assembly 125, by executing software or instructions obtained from a local non-transitory computer readable media (e.g., optical disks, magnetic disks). The non-transitory computer readable media may store software or instructions of the methods described herein. Non-transitory computer readable media may include any instrumentality or aggregation of instrumentalities that may retain data and/or instructions for a period of time. Non-transitory computer readable media may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 134 may also include input device(s) (e.g., keyboard, mouse, touchpad, etc.) and output device(s) (e.g., monitor, printer, etc.). The input device(s) and output device(s) provide a user interface that enables an operator to interact with any device disposed or a part of bottom-hole assembly 125, discussed below, and/or software executed by a processing unit. For example, information handling system 134 may enable an operator to select analysis options, view collected log data, view analysis results, and/or perform other tasks.

Non-limiting examples of techniques for transferring tool measurement data (to the surface) include mud pulse telemetry and through-wall acoustic signaling. For through-wall acoustic signaling, one or more repeater(s) may detect, amplify, and re-transmit signals from bottom-hole assembly 125 to the surface (e.g., to information handling system 134), and conversely, from the surface (e.g., from information handling system 134) to bottom-hole assembly 125.

A repeater is a device which may be used to receive and send signals from one component of wellbore operating environment 100 to another component of drilling environment 100. As a non-limiting example, repeater may be used to receive a signal from a tool on bottom-hole assembly 125 and send that signal to information handling system 134. Two or more repeaters may be used together, in series, such that a signal to/from bottom-hole assembly 125 may be relayed through two or more repeaters before reaching its destination.

In some embodiments, one or more of the logging tools 126 may communicate with a surface receiver 130, such as a wired drill pipe. In other cases, one or more of the logging tools 126 may communicate with a surface receiver 130 by wireless signal transmission. Surface receiver 130 may further transfer data received to information handling system 134. Additionally information handling system 134 may use surface receiver 130 to communicate with logging tools 126. In at least some cases, one or more of the logging tools 126 may receive electrical power from a wire that extends to the surface, including wires extending through a wired drill pipe. In at least some instances the methods and techniques of the present disclosure may be performed by a computing device (not shown) on the surface. In some embodiments, the computing device may be included in surface receiver 130. For example, surface receiver 130 of wellbore operating environment 100 at the surface may include one or more of wireless telemetry, processor circuitry, or memory facilities, such as to support substantially real-time processing of data received from one or more of the logging tools 126. In some embodiments, data is processed at some time subsequent to its collection, wherein the data may be stored on the surface at surface receiver 130, stored downhole in telemetry sub 128, or both, until it is retrieved for processing.

Additionally, communications may be performed at least in part by a transducer. A transducer is a device which may be configured to convert non-digital data (e.g., vibrations, other analog data) into a digital form suitable for information handling system 134. As a non-limiting example, one or more transducer(s) may convert signals between mechanical and electrical forms, enabling information handling system 134 to receive the signals from a telemetry sub, on bottom-hole assembly 125, and conversely, transmit a downlink signal to the telemetry sub on bottom-hole assembly 125. In any embodiment, transducer may be located at the surface and/or any part of drill string 108 (e.g., as part of bottom-hole assembly 125).

Drill bit 114 is a machine which may be used to cut through, scrape, and/or crush (i.e., break apart) materials in the ground (e.g., rocks, dirt, clay, etc.). Drill bit 114 may be disposed at the frontmost point of drill string 108 and bottom-hole assembly 125. In any embodiment, drill bit 114 may include one or more cutting edges (e.g., hardened metal points, surfaces, blades, protrusions, etc.) to form a geometry which aids in breaking ground materials loose and further crushing that material into smaller sizes. In any embodiment, drill bit 114 may be rotated and forced into (i.e., pushed against) the ground material to cause the cutting, scraping, and crushing action. The rotations of drill bit 114 may be caused by top drive 110 and/or one or more motor(s) located on drill string 108 (e.g., on bottom-hole assembly 125).

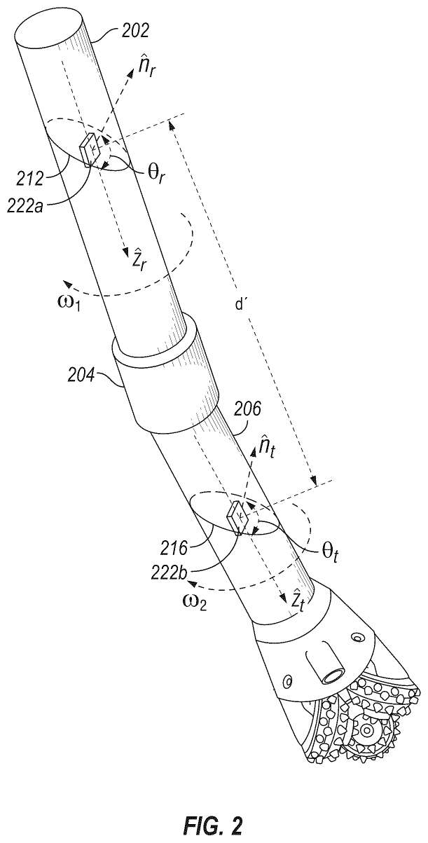

FIG. 2 shows an illustrative example of a deep formation evaluation logging tool that includes two LWD tool modules 202 and 206 at different locations and orientations along a drill string. In the example shown, a resistivity logging tool receive antenna 212 and a corresponding receive antenna position measurement device 222 a may be housed within LWD tool module 202, while a resistivity logging tool transmit antenna 216 and a corresponding transmit antenna position measurement device 222 b (components of an “at bit” instrument) are housed within LWD tool module 206. The position measurement devices may locate the position of each corresponding antenna, which may be expressed, for example, in terms of each antenna's tilt angle (θᵣ and θₜ relative to the zᵣ and zₜ axes respectively; generally fixed and known), each antenna's azimuthal angle (αᵣ and αₜ relative to the x axis), each LWD tool module's inclination angle (φᵣ and φₜ) and the distance d′ between the antennas. Various methods may be used to locate the antenna positions (e.g., relative to a reference position on the surface), several of which are described in more detail below. It should be noted that although the bent sub angles are typically less than five degrees, the figures show much more pronounced angles to better illustrate the effect of the angles on the relative spatial locations of the antennas, described in more detail below.

The above-described antenna and LWD tool module orientations may be used to calibrate tool responses prior to performing an inversion process to model the surrounding formation. Such calibration is performed in order to be able to compare the modeled and measure results, as the modeled results assume known and fixed orientations and spatial locations of the resistivity logging tool transmit and receive antennas relative to each other, but the measured results may originate from antennas with any of a number of different relative orientations and spatial locations other than those presumed in the model. Measured and modeled results may be in the form of complex voltages, complex currents, resistivity values derived from measured/modeled voltages and/or currents, and/or ratios of voltages, currents and/or resistivities, just to name a few examples. Part of this calibration can be performed mathematically as one or more matrix rotations, while another part may be performed as a derivation of the relative spatial locations of and/or distance between antennas based on the antennas' locations and orientations. The resulting calibrated response is provided to the inversion, which uses these inputs to model the formation.

Equation (1), expressed more simply in equation (2), illustrates the rotation portion of the calibration process, taking into account each of the above-described angles:

$${V}_{R}^{T} ( {t}_{0} ) = {[ \begin{matrix}sin ( {θ}_{t} + {∅}_{t} ( {t}_{0} ) ) cos ( {∝}_{t} ( {t}_{0} ) ) \\ sin ( {θ}_{t} + {∅}_{t} ( {t}_{0} ) ) sin ( ∝ ( {t}_{0} ) ) \\ cos ( {θ}_{t} + {∅}_{t} ( {t}_{0} ) )\end{matrix} ]}^{T} [ \begin{matrix}{V}_{x}^{x} ( {t}_{0} ) & {V}_{y}^{x} ( {t}_{0} ) & {V}_{z}^{x} ( {t}_{0} ) \\ {V}_{x}^{y} ( {t}_{0} ) & {V}_{y}^{y} ( {t}_{0} ) & {V}_{z}^{y} ( {t}_{0} ) \\ {V}_{x}^{z} ( {t}_{0} ) & {V}_{y}^{z} ( {t}_{0} ) & {V}_{z}^{z} ( {t}_{0} )\end{matrix} ] [ \begin{matrix}sin ( {θ}_{r} + {∅}_{t} ( {t}_{0} ) ) cos ( {∝}_{r} ( {t}_{0} ) ) \\ sin ( {θ}_{r} + {∅}_{r} ( {t}_{0} ) ) sin ( {∝}_{r} ( {t}_{0} ) ) \\ cos ( {θ}_{r} + {∅}_{r} ( {t}_{0} ) )\end{matrix} ] \qquad ( 1 )$$

$${V}_{R}^{T} ( {t}_{0} ) = {T}_{VECTOR}^{T} ( {t}_{0} ) * {V}_{MATRIX} ( {t}_{0} ) * {R}_{VECTOR} ( {t}_{0} ) \qquad ( 2 )$$

where T_{VECTOR}^{T}(t₀) (shown in transposed form for convenience) is given by the transmit antenna's known tilt angle θₜ, and by the inclination angle Øₜ and azimuthal angle ∝ₜ as determined by the transmit antenna's position measurement device at time t₀; R_{VECTOR}(t₀) is given by the receive antenna's known tilt angle θᵣ, and by the inclination angle Øᵣ azimuthal angle ∝ᵣ as determined by the receive antenna's position measurement device at time t₀; and V_{MATRIX}(t₀) is a 3×3 voltage matrix consisting of nine components Vⱼⁱ. Each component represents a theoretical voltage a receive antenna with a j axis orientation (x, y or z) in response to a signal from a transmit antenna with an i axis orientation (also x, y or z) for a given formation model, operating frequency and spacing d′.

Another part of the calibration may involve determining the distance between the transmit antenna and the receive antenna. The distance between transmit and receive antennas changes when two or more LWD tool modules are positioned such that they no longer share a common z axis. For example, in FIG. 2 both LWD tool modules 202 and 206 are inclined such that each z axis (zᵣ and zₜ) is inclined at a different inclination angle ϕ (ϕᵣ and ϕₜ) relative to a vertical reference z axis. The inclination angle change reduces the original distance between the receive and transmit antennas 212 and 216 from original distance d when the drillstring was straight (bent sub 204 set to 0 degrees) to distance d′.

As a further complication to measuring formation resistivity, boreholes are generally perpendicular to formation beds. The angle between the axis of the well bore and the orientation of the formation beds (as represented by the normal vector) has two components. These components are the dip angle and the azimuth angle. The dip angle is the angle between the borehole axis and the normal vector for the formation bed. The azimuth angle is the direction in which the borehole's axis “leans away from” the normal vector. Electromagnetic resistivity logging measurements are a complex function of formation resistivity, formation anisotropy, and the formation dip and azimuth angles, which may all be unknown. A triaxial induction well logging tool may be used to detect formation properties such as resistivity anisotropy, which is one of the important parameters in evaluation subterranean formations such as sand-shale reservoirs or fractured reservoirs. However, the resistivity anisotropy parameter cannot be obtained without performing a numerical inversion process. Specifically, numerical inversion may be utilized to obtain accurate formation resistivity anisotropy parameters. The log inversion utilized for anisotropy determination may involve a large number of inversion parameters to be determined by an algorithm referred to as the ID vertical inversion. Generally, this algorithm may utilize large amounts of processing time and be sensitive to noise from logging, the logging environment characteristics and borehole correction, which could result in errors in the inverted vertical resistivity.

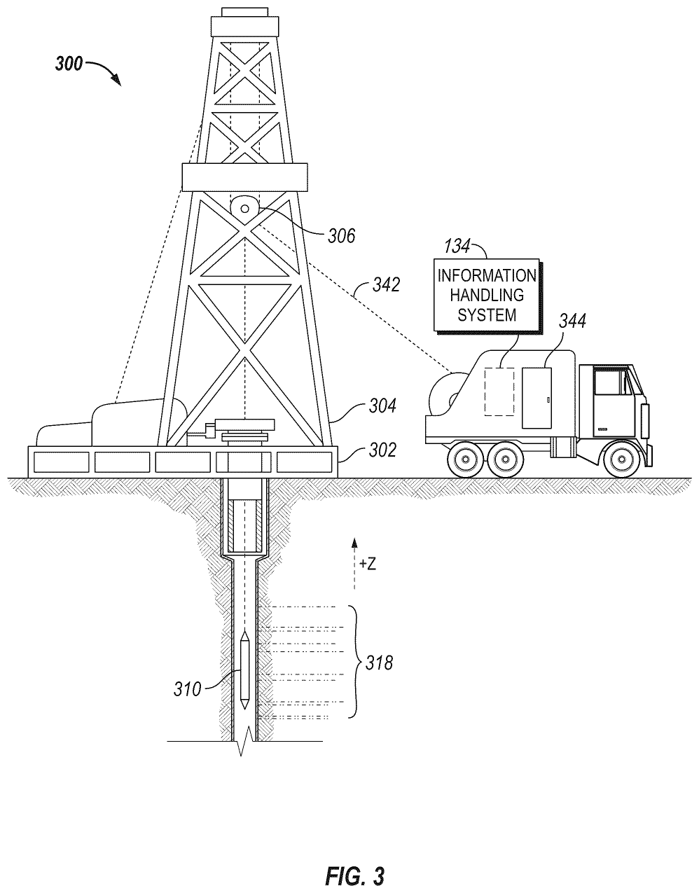

FIG. 3 illustrates a diagrammatic view of a conveyance logging wellbore operating environment 300 in which the present disclosure may be implemented. As depicted in FIG. 3, a hoist 306 may be included as a portion of a platform 302, such as that coupled to derrick 304, and used with a conveyance 342 to raise or lower equipment such as resistivity logging tool 310 into or out of a borehole. Resistivity logging tool 310 may include, for example, tools such as the one shown in FIG. 4. A conveyance 342 may provide a communicative coupling between the resistivity logging tool 310 and a logging facility 344 at the surface. The conveyance 342 may include wires (one or more wires), slicklines, cables, or the like, as well as tubular conveyances such as coiled tubing, joint tubing, or other tubulars, and may include a downhole tractor. Additionally, power may be supplied via conveyance 342 to meet power needs of the tool. The resistivity logging tool 310 may have a local power supply, such as batteries, downhole generator and the like. When employing non-conductive cable, coiled tubing, pipe string, or downhole tractor, communication may be supported using, for example, wireless protocols (e.g., EM, acoustic, etc.), and/or measurements and logging data may be stored in local memory for subsequent retrieval. Logging facility 344 may include information handling system 134 capable of carrying out the methods and techniques of the present disclosure. In this manner, information about the formation 318 may be obtained by resistivity logging tool 310 and processed by a computing device, such as information handling system 134. In some embodiments, information handling system 134 is equipped to process the received information in substantially real-time, while in some embodiments, information handling system 134 can be equipped to store the received information for processing at some subsequent time.

FIG. 4 illustrates an example wellbore tool 400 that may be used in the systems and methods described herein. Wellbore tool 400 may comprise transmitter sub 405 and one or more receiver subs 410, 411, and 412. In some examples, transmitter sub 405 may be referred to as TX and receiver subs 410, 411, and 412 may be referred to as RX1, RX2, and RX3 respectively. Transmitter sub 405 may comprise a transmitter coil 406 which may be an electromagnetic wave source such as a monopole, dipole, quadrupole, or other higher order wave source. Each of the receiver subs 410, 411, and 412 may comprise three or more receiver coils per sub configured to receive an electromagnetic wave from transmitter sub 405. Receiver subs 410, 411, and 412 may be disposed on wellbore tool 400 a distance 415, 416, 417 from transmitter sub 105. Distance 415, 416, 417 may also be referred to as S1, S2, and S3 respectively.

Referring to FIG. 4 and FIG. 2, first receiver coils 420 are not co-axial with receiver sub 410. There may be an axial offset between first receiver coils 420 and a centerline of receiver sub 410 which may be notated as θ_{R1}. Similarly, for transmitter coil 406, second receiver coils 421, and third receiver coils 422, there may be an axial offset of coils from a centerline of the respective subs notated as θ_{T}, θ_{R2}, and θ_{R3} respectively. In addition to axial offset, each of the first receiver coils 420, second receiver coils 421, and third receiver coils 422 may have an azimuthal offset relative to transmitter coil 406. The tilt angle of the transmitter coil is notated as θ_{T} and the tilt angle, or azimuthal offset, of each of the receiver coils is notated as θ_{R1}, θ_{R2}, and θ_{R3} for RX1, RX2, and RX3 respectively. The azimuth angle is dependent on wellbore tool's 400 rotated position in wellbore 116 (e.g., referring to FIG. 1). In examples, although not illustrated, β_{off} is the difference in azimuthal angle between the transmitter coil and the second receiver coil which may be measured before the tool is inserted into wellbore 116. Further, β_{Δ1} is the difference in azimuthal angle between the first receiver coil 420 and the second receiver coil 421 and β_{Δ2} is the difference in azimuthal angle between the third receiver coil 422 and second receiver coil 420. In examples, variables β_{Δ1} and β_{Δ2} may take any value but may follow the following parameters: (1) β_{Δ1}≠β_{Δ2}, (2) β_{Δ1}≠0°, and (3) β_{Δ2}≠0°.

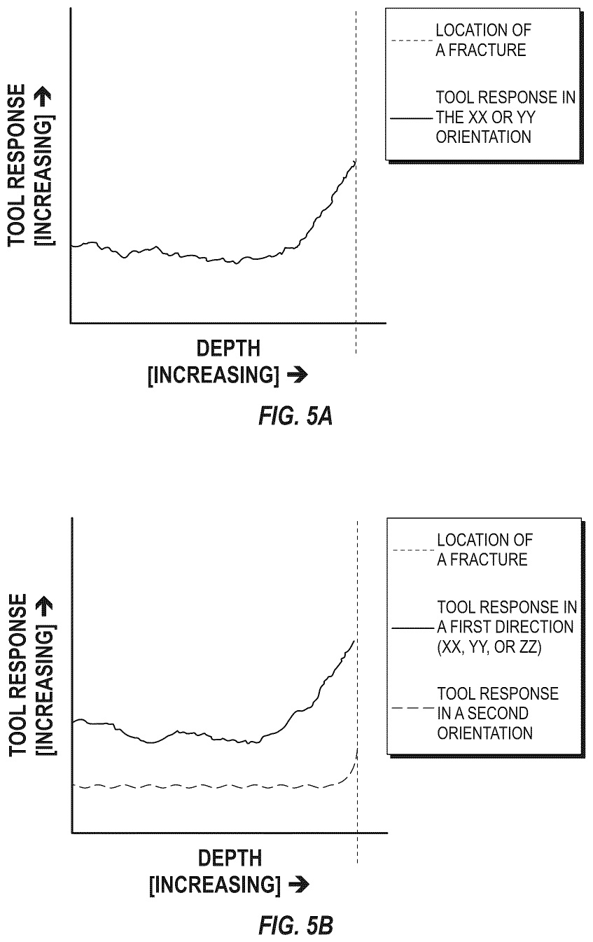

In some examples, the gradient change of raw measurements in the x-direction or y-direction in comparison to the z-direction may be used to identify a deviation in formation properties such as a fault. FIG. 5A may depict a resistivity plot in a single orientation which may be used to identify a deviation in formation properties ahead of wellbore 116. The deviation in formation properties may include a fracture or fault. FIG. 5A may further depict a resistivity response in the XX- or YY-direction. The XX, YY and ZZ directions may be three specific components from the calculated nine component matrix from Equation (1). In examples, transmitter coil 406 (e.g., referring to FIG. 4) may be oriented along the XX direction. Further, an x-oriented transmitter firing may be received by x-oriented receiver coils 420 along the XX direction. The XX direction may be defined by high-side or magnetic north in the LWD system. In examples, transmitter coil 406 (e.g., referring to FIG. 4) may be oriented along the ZZ direction. Further, a z-oriented transmitter firing may be received by z-oriented receiver coils 420 along the ZZ direction. The ZZ direction may be the direction of the well trajectory. Further, ZZ measurement may be referred to as z-oriented receiver measurements with respect to the z-oriented transmitter firing. In examples, transmitter coil 406 (e.g., referring to FIG. 4) may be oriented along the YY direction. Further, a y-oriented transmitter firing may be received by y-oriented receiver coils 420 along the YY direction. The YY direction may be a direction normal to the XX and YY directions, such that the XX-YY, XX-ZZ, YY-ZZ planes are all normal. Further, YY measurement may be referred to as y-oriented receiver measurements with respect to the y-oriented transmitter firing.

In some examples the wellbore depth may be measured in total vertical depth (“TVD”) or in measured depth (“MD”). As the resistivity tool approaches a portion of the subterranean formation with different formation properties, such as a fracture, measurements taken in the XX- or YY-direction may show a deviation from the previously acquired measurements. In some examples, measurements taken in the XX- or YY-direction may be more sensitive to changes in formation properties located ahead of the tool while measurements taken in the ZZ-direction may be less sensitive. In further examples, measurements in the XX-direction may be more sensitive to changes ahead of the wellbore than changes in the YY-direction. However, in some formations, changes in the YY-direction may be more sensitive than changes in the XX-direction. In some examples, measurements taken in the XX- or YY-direction may be able to detect a fracture located at further distances away from the tool than measurements in the ZZ-direction. For example, if the measurements in either the XX- or YY-direction deviate from a given threshold, it may indicate the presence of a fracture or fault. Wellbore tool's 400 (e.g., referring to FIG. 4) response in FIG. 5A depicts a deviation from the previous responses as wellbore tool 400 approaches the depth of the fracture. This deviation may indicate that wellbore tool 400 is approaching a fracture before the wellbore is extended through the fracture. If a potential fracture is detected, it may be desirable to modify the trajectory of the wellbore in order to steer the drilling assembly around the fracture.

FIG. 5B may depict the comparison of resistivity values acquired in two orientations relative to the wellbore depth. For example, the y-axis of FIG. 5B may depict the tool response while the x-axis depicts a wellbore depth in TVD or MD. The data plotted in FIG. 5B may include responses from wellbore tool 400 from two different orientations which may be used to compare the responses from the two orientations. The comparison may include sequential resistivity measurements taken from the directions of XX-YY, XX-ZZ, or YY-ZZ as a function of wellbore depth. In further examples, the comparison may use measurements taken at different frequencies or different spacings between the transmitter and receiver. As previously mentioned, measurements taken in the XX- or YY-direction may be more sensitive to changes in formation properties located ahead of wellbore tool 400 than measurements in the ZZ-direction. In some examples, measurements taken in the XX- or YY-direction may be able to detect a fracture located at further distances away from the tool than measurements in the ZZ-direction. Additionally, measurements taken in the XX-direction may be more or less sensitive than measurements taken in the YY-direction. Comparing the changes in the resistivity responses from two orientations may highlight the presence of a fracture or fault ahead of wellbore 116 (e.g., referring to FIG. 1). If a potential fracture is detected, it may be desirable to modify the trajectory of wellbore 116 in order to steer the drilling assembly around the fracture.

As noted above, wellbore tool 400 comprises one or more subs, as described above (e.g., referring to FIG. 4). As each of the one or more subs create a multi-collar configuration of bottom-hole assembly 125, it is difficult to establish azimuthal alignment between coils. Consequently, measurements from receiver coil 420 may utilize more complex signal processing algorithms to identify and compensate for misalignment with transmitter antenna 406. Having corrected for azimuthal misalignment, the system calculates the multi-component signals at various frequencies and spacings with respect to tilted transmitter coil 406 firing. The multi-component signals then pass into an unconstrained, point-by-point, one-dimensional (1D) inversion process to determine the surrounding multi-layered formation structure. The inversion process may be performed utilizing information handling system 134.

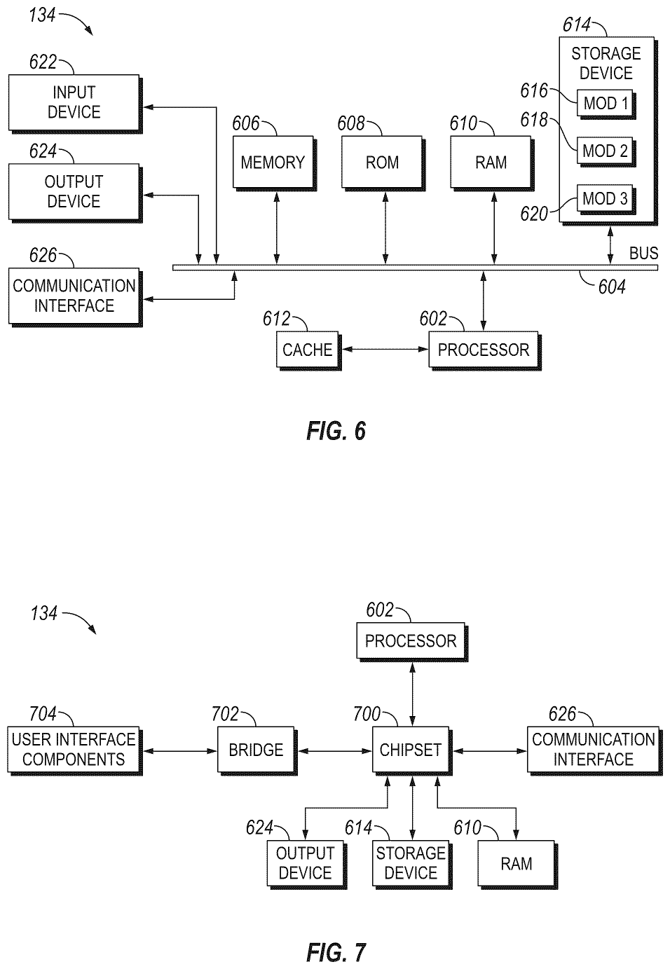

FIG. 6 further illustrates an example information handling system 134 which may be employed to perform various steps, methods, and techniques disclosed herein. Persons of ordinary skill in the art will readily appreciate that other system examples are possible. As illustrated, information handling system 134 includes a processing unit (CPU or processor) 602 and a system bus 604 that couples various system components including system memory 606 such as read only memory (ROM) 608 and random-access memory (RAM) 610 to processor 602. Processors disclosed herein may all be forms of this processor 602. Information handling system 134 may include a cache 612 of high-speed memory connected directly with, in close proximity to, or integrated as part of processor 602. Information handling system 134 copies data from memory 606 and/or storage device 614 to cache 612 for quick access by processor 602. In this way, cache 612 provides a performance boost that avoids processor 602 delays while waiting for data. These and other modules may control or be configured to control processor 602 to perform various operations or actions. Other system memory 606 may be available for use as well. Memory 606 may include multiple different types of memory with different performance characteristics. It may be appreciated that the disclosure may operate on information handling system 134 with more than one processor 602 or on a group or cluster of computing devices networked together to provide greater processing capability. Processor 602 may include any general-purpose processor and a hardware module or software module, such as first module 616, second module 618, and third module 620 stored in storage device 614, configured to control processor 602 as well as a special-purpose processor where software instructions are incorporated into processor 602. Processor 602 may be a self-contained computing system, containing multiple cores or processors, a bus, memory controller, cache, etc. A multi-core processor may be symmetric or asymmetric. Processor 602 may include multiple processors, such as a system having multiple, physically separate processors in different sockets, or a system having multiple processor cores on a single physical chip. Similarly, processor 602 may include multiple distributed processors located in multiple separate computing devices but working together such as via a communications network. Multiple processors or processor cores may share resources such as memory 606 or cache 612 or may operate using independent resources. Processor 602 may include one or more state machines, an application specific integrated circuit (ASIC), or a programmable gate array (PGA) including a field PGA (FPGA).

Each individual component discussed above may be coupled to system bus 604, which may connect each and every individual component to each other. System bus 604 may be any of several types of bus structures including a memory bus or memory controller, a peripheral bus, and a local bus using any of a variety of bus architectures. A basic input/output (BIOS) stored in ROM 608 or the like, may provide the basic routine that helps to transfer information between elements within information handling system 134, such as during start-up. Information handling system 134 further includes storage devices 614 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 614 may include software modules 616, 618, and 620 for controlling processor 602. Information handling system 134 may include other hardware or software modules. Storage device 614 is connected to the system bus 604 by a drive interface. The drives and the associated computer-readable storage devices provide nonvolatile storage of computer-readable instructions, data structures, program modules and other data for information handling system 134. In one aspect, a hardware module that performs a particular function includes the software component stored in a tangible computer-readable storage device in connection with hardware components, such as processor 602, system bus 604, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 134 is a small, handheld computing device, a desktop computer, or a computer server. When processor 602 executes instructions to perform “operations”, processor 602 may perform the operations directly and/or facilitate, direct, or cooperate with another device or component to perform the operations.

As illustrated, information handling system 134 employs storage device 614, which may be a hard disk or other types of computer-readable storage devices which may store data that are accessible by a computer, such as magnetic cassettes, flash memory cards, digital versatile disks (DVDs), cartridges, random access memories (RAMs) 610, read only memory (ROM) 608, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 134, an input device 622 represents any number of input mechanisms, such as a microphone for speech, a touch-sensitive screen for gesture or graphical input, keyboard, mouse, motion input, speech and so forth. Additionally, input device 622 may receive one or more measurements from bottom-hole assembly 125 (e.g., referring to FIG. 1), discussed above. An output device 624 may also be one or more of a number of output mechanisms known to those of skill in the art. In some instances, multimodal systems enable a user to provide multiple types of input to communicate with information handling system 134. Communications interface 626 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 602, that is purpose-built to operate as an equivalent to software executing on a general-purpose processor. For example, the functions of one or more processors presented in FIG. 6 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 608 for storing software performing the operations described below, and random-access memory (RAM) 610 for storing results. Very large-scale integration (VLSI) hardware embodiments, as well as custom VLSI circuitry in combination with a general-purpose DSP circuit, may also be provided.

FIG. 7 illustrates an example information handling system 134 having a chipset architecture that may be used in executing the described method and generating and displaying a graphical user interface (GUI). Information handling system 134 is an example of computer hardware, software, and firmware that may be used to implement the disclosed technology. Information handling system 134 may include a processor 602, representative of any number of physically and/or logically distinct resources capable of executing software, firmware, and hardware configured to perform identified computations. Processor 602 may communicate with a chipset 700 that may control input to and output from processor 602. In this example, chipset 700 outputs information to output device 624, such as a display, and may read and write information to storage device 614, which may include, for example, magnetic media, and solid-state media. Chipset 700 may also read data from and write data to RAM 610. A bridge 702 for interfacing with a variety of user interface components 704 may be provided for interfacing with chipset 700. Such user interface components 704 may include a keyboard, a microphone, touch detection and processing circuitry, a pointing device, such as a mouse, and so on. In general, inputs to information handling system 134 may come from any of a variety of sources, machine generated and/or human generated.

Chipset 700 may also interface with one or more communication interfaces 626 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 602 analyzing data stored in storage device 614 or RAM 610. Further, information handling system 134 receives inputs from a user via user interface components 704 and executes appropriate functions, such as browsing functions by interpreting these inputs using processor 602.

In examples, information handling system 134 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

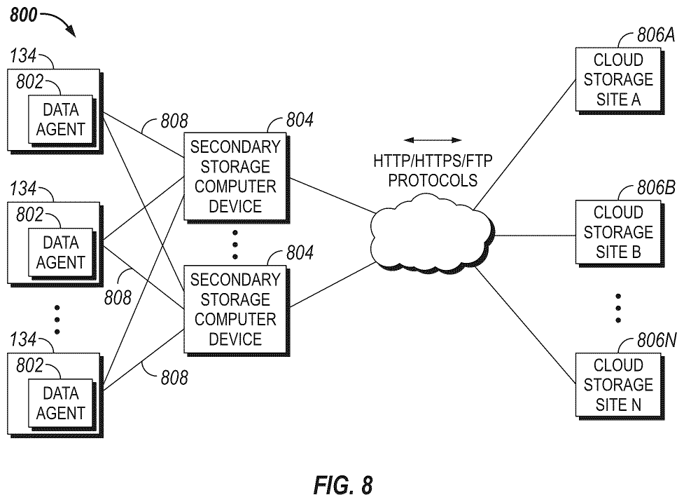

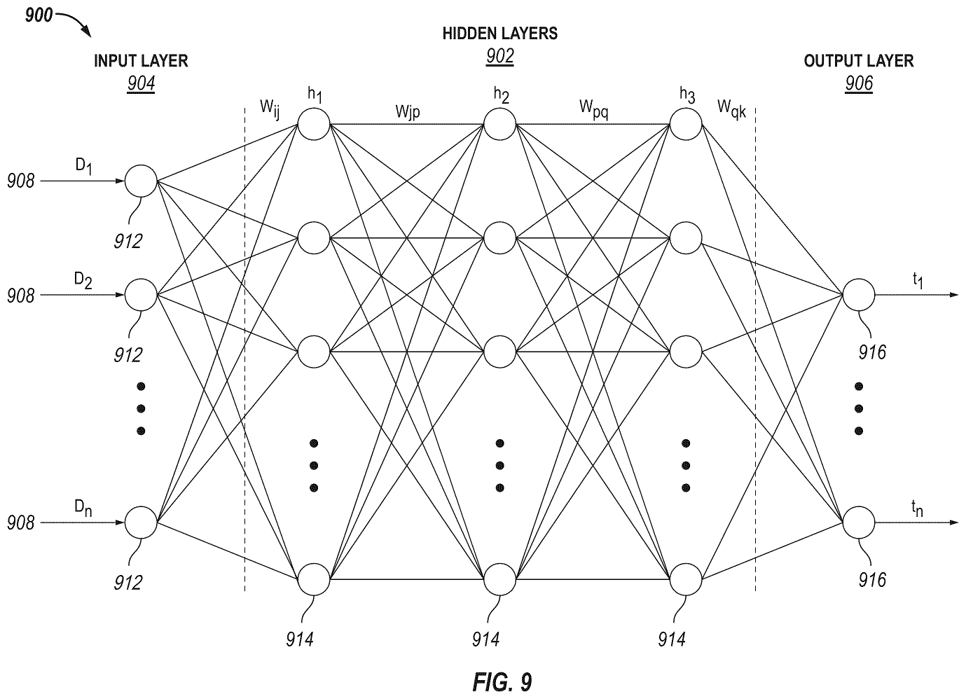

FIG. 8 illustrates an example of one arrangement of resources in a computing network 800 that may employ the processes and techniques described herein, although many others are of course possible. As noted above, an information handling system 134, as part of their function, may utilize data, which includes files, directories, metadata (e.g., access control list (ACLS) creation/edit dates associated with the data, etc.), and other data objects. The data on the information handling system 134 is typically a primary copy (e.g., a production copy). During a copy, backup, archive or other storage operation, information handling system 134 may send a copy of some data objects (or some components thereof) to a secondary storage computing device 804 by utilizing one or more data agents 802.

A data agent 802 may be a desktop application, website application, or any software-based application that is run on information handling system 134. As illustrated, information handling system 134 may be disposed at any rig site (e.g., referring to FIG. 1), off site location, or repair and manufacturing center. The data agent may communicate with a secondary storage computing device 804 using communication protocol 808 in a wired or wireless system. Communication protocol 808 may function and operate as an input to a website application. In the website application, field data related to pre- and post-operations, generated DTCs, notes, and the like may be uploaded. Additionally, information handling system 134 may utilize communication protocol 808 to access processed measurements, operations with similar DTCs, troubleshooting findings, historical run data, and/or the like. This information is accessed from secondary storage computing device 804 by data agent 802, which is loaded on information handling system 134.

Secondary storage computing device 804 may operate and function to create secondary copies of primary data objects (or some components thereof) in various cloud storage sites 806A-N. Additionally, secondary storage computing device 804 may run determinative algorithms on data uploaded from one or more information handling systems 134, discussed further below. Communications between the secondary storage computing devices 804 and cloud storage sites 806A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 806A-N, the secondary storage computing device 804 may also perform local content indexing and/or local object-level, sub-object-level or block-level deduplication when performing storage operations involving various cloud storage sites 806A-N. Cloud storage sites 806A-N may further record and maintain, EM logs, map DTC codes, store repair and maintenance data, store operational data, and/or provide outputs from determinative algorithms that are located in cloud storage sites 806A-N. In a non-limiting example, this type of network may be utilized as a platform to store, backup, analyze, import, preform extract, transform and load (“ETL”) processes, mathematically process, apply machine learning models, and augment EM measurement data sets.

A machine learning model may be an empirically derived model which may result from a machine learning algorithm identifying one or more underlying relationships within a dataset. In comparison to a physics-based model, such as Maxwell's Equations, which are derived from first principles and define the mathematical relationship of a system, a pure machine learning model may not be derived from first principles. Once a machine learning model is developed, it may be queried in order to predict one or more outcomes for a given set of inputs. The type of input data used to query the model to create the prediction may correlate both in category and type to the dataset from which the model was developed.

The structure of, and the data contained within a dataset provided to a machine learning algorithm may vary depending on the intended function of the resulting machine learning model. The rows of data, or data points, within a dataset may contain one or more independent values. Additionally, datasets may contain corresponding dependent values. The independent values of a dataset may be referred to as “features,” and a collection of features may be referred to as a “feature space.” If dependent values are available in a dataset, they may be referred to as outcomes or “target values.” Although dependent values may be a component of a dataset for certain algorithms, not all algorithms may utilize a dataset with dependent values. Furthermore, both the independent and dependent values of the dataset may comprise either numerical or categorical values.

While it may be true that machine learning model development is more successful with a larger dataset, it may also be the case that the whole dataset isn't used to train the model. A test dataset may be a portion of the original dataset which is not presented to the algorithm for model training purposes. Instead, the test dataset may be used for what may be known as “model validation,” which may be a mathematical evaluation of how successfully a machine learning algorithm has learned and incorporated the underlying relationships within the original dataset into a machine learning model. This may include evaluating model performance according to whether the model is over-fit or under-fit. As it may be assumed that all datasets contain some level of error, it may be important to evaluate and optimize the model performance and associated model fit by a model validation. In general, the variability in model fit (e.g.: whether a model is over-fit or under-fit) may be described by the “bias-variance trade-off.” As an example, a model with high bias may be an under-fit model, where the developed model is over-simplified, and has either not fully learned the relationships within the dataset or has over-generalized the underlying relationships. A model with high variance may be an over-fit model which has overlearned about non-generalizable relationships within training dataset which may not be present in the test dataset. In a non-limiting example, these non-generalizable relationships may be driven by factors such as intrinsic error, data heterogeneity, and the presence of outliers within the dataset. The selected ratio of training data to test data may vary based on multiple factors, including, in a non-limiting example, the homogeneity of the dataset, the size of the dataset, the type of algorithm used, and the objective of the model. The ratio of training data to test data may also be determined by the validation method used, wherein some non-limiting examples of validation methods include k-fold cross-validation, stratified k-fold cross-validation, bootstrapping, leave-one-out cross-validation, resubstituting, random subsampling, and percentage hold-out.

In addition to the parameters that exist within the dataset, such as the independent and dependent variables, machine learning algorithms may also utilize parameters referred to as “hyperparameters.” Each algorithm may have an intrinsic set of hyperparameters which guide what and how an algorithm learns about the training dataset by providing limitations or operational boundaries to the underlying mathematical workflows on which the algorithm functions. Furthermore, hyperparameters may be classified as either model hyperparameters or algorithm parameters.

Model hyperparameters may guide the level of nuance with which an algorithm learns about a training dataset, and as such model hyperparameters may also impact the performance or accuracy of the model that is ultimately generated. Modifying or tuning the model hyperparameters of an algorithm may result in the generation of substantially different models for a given training dataset. In some cases, the model hyperparameters selected for the algorithm may result in the development of an over-fit or under-fit model. As such, the level to which an algorithm may learn the underlying relationships within a dataset, including the intrinsic error, may be controlled to an extent by tuning the model hyperparameters.

Model hyperparameter selection may be optimized by identifying a set of hyperparameters which minimize a predefined loss function. An example of a loss function for a supervised regression algorithm may include the model error, wherein the optimal set of hyperparameters correlates to a model which produces the lowest difference between the predictions developed by the produced model and the dependent values in the dataset. In addition to model hyperparameters, algorithm hyperparameters may also control the learning process of an algorithm, however algorithm hyperparameters may not influence the model performance. Algorithm hyperparameters may be used to control the speed and quality of the machine learning process. As such, algorithm hyperparameters may affect the computational intensity associated with developing a model from a specific dataset.

Machine learning algorithms, which may be capable of capturing the underlying relationships within a dataset, may be broken into different categories. One such category may include whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset includes both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may include Neural Networks, K-Nearest Neighbors, Naïve Bayes, Decision Trees, Classification Trees, Regression Trees, Random Forests, Linear Regression, Support Vector Machines (SVM), Gradient Boosting Regression, and Perception Back-Propagation.

The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not include a dependent variable as the intended function of this type of algorithm is to identify one or more groupings or clusters within a dataset. In a non-limiting example, algorithms which may be utilized for unsupervised machine learning may include K-means clustering, K-means classification, Fuzzy C-Means, Gaussian Mixture, Hidden Markov Model, Neural Networks, and Hierarchical algorithms.

In examples to determine a relationship using machine learning, a neural network (NN) 900, as illustrated in FIG. 9, may be utilized to model a three-dimensional finite element BHA to analyze lateral deflection experienced by BHA 125 (e.g., referring to FIG. 1) in both its lateral deflection in both inclination and pseudo-azimuth planes in a curved wellbore 116 (e.g., referring to FIG. 1). FIG. 9 illustrates neural network (NN) 900. NN 900 may operate utilizing one or more information handling systems 134 (e.g., referring to FIG. 1) on computing network 800. Although a NN is illustrated, multiple models may be used with input output structures. These models may include flexible empirical models such as NN, gaussian processing methods, kriging methods, evolutionary methods such as genetic algorithms, classification methods, clustering methods empirical methods, or physics based methods such as equations of state, thermodynamic models, geological, geochemistry, or chemistry models, or kinetic models or any combinations therein including recursive combinations of similar or dissimilar models and iterative model combinations. A NN 900 is an artificial neural network with one or more hidden layers 902 between input layer 904 and output layer 906. In examples, NN 900 may be software on a single information handling system 134. In other examples, NN 900 may software running on multiple information handling systems 134 connected wirelessly and/or by a hard-wired connection in a network of multiple information handling systems 134. Herein, NN 900 may be applied in a wide array of implementations.

During operations, inputs 908 data are given to neurons 912 in input layer 904. Neurons 912, 914, and 916 are defined as individual or multiple information handling systems 134 connected in a computing network 800. The output from neurons 912 may be transferred to one or more neurons 914 within one or more hidden layers 902. Hidden layers 902 includes one or more neurons 914 connected in a network that further process information from neurons 912. The number of hidden layers 902 and neurons 912 in hidden layer 902 may be determined by personnel that designs NN 900. Hidden layers 902 is defined as a set of information handling system 134 assigned to specific processing. Hidden layers 902 spread computation to multiple neurons 912, which may allow for faster computing, processing, training, and learning by NN 900. Output from NN 900 may be computed by neurons 916. An information handling system 134 (e.g., referring to FIG. 1) being utilized in a computing network 800, NN 900, or alone may be utilized for inversion techniques to create models from resistivity measurements taken during measurement operations, as discussed above. Because of the deep detection range of wellbore tool 400 (e.g., referring to FIG. 4), the conventional model-based Gauss-Newton minimization inversion approach is not sufficient because of the existence of local minima and solution ambiguities in the inversion problem. Consequently, the inversion process uses many random initial models to include as many layers as possible and to explore as many local and global minima as possible. This approach enables the inversion process to capture different numbers of hidden layers 902 and provides a greater probability of attaining the global minimum solution(s), rather than local minimum solutions.

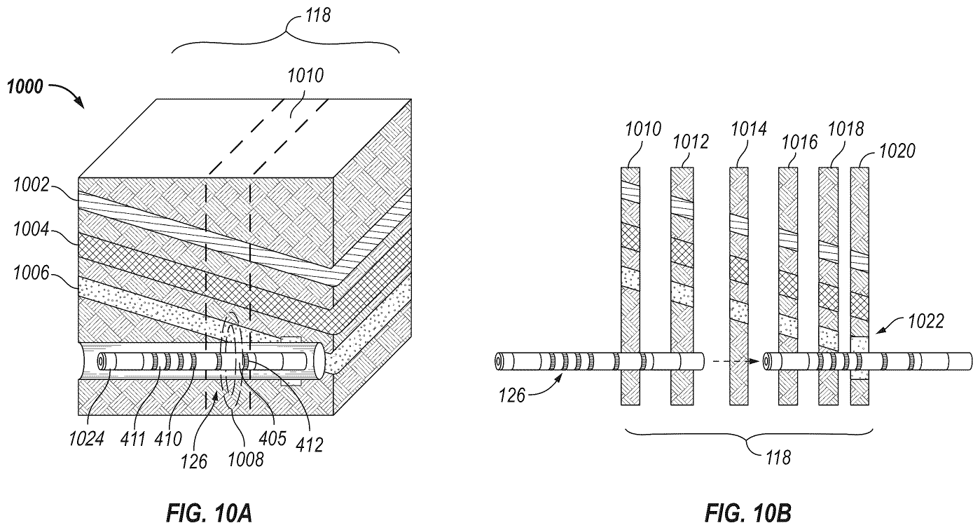

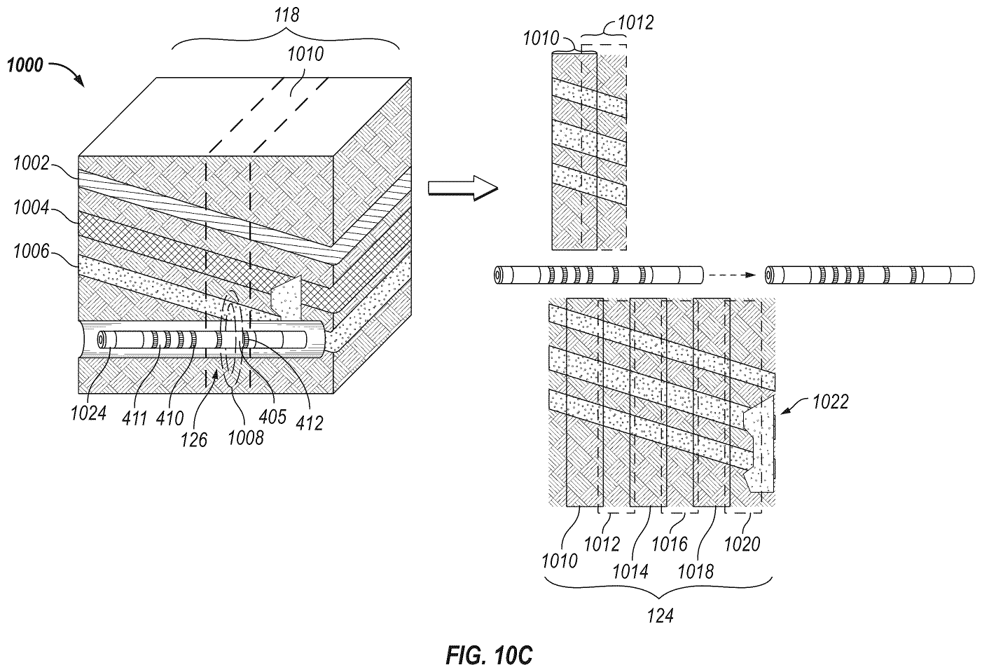

FIG. 10A illustrates measurement operations 1000 that may be performed during LWD and/or MWD wellbore operating environment 100 (e.g., referring to FIG. 1) or conveyance logging operations 300 (e.g., referring to FIG. 3). As illustrated in FIG. 10A logging tool 126 may traverse through a subterranean formation 118 in borehole 1024. Subterranean formation 118 may comprise a first formation feature 1002, a second formation feature 1004, and/or a third formation feature 1006. During operations transmitter sub 405 may transmit an electromagnetic wave 1008 into first formation feature 1002, a second formation feature 1004, and/or a third formation feature 1006 at a first depth 1010. Electromagnetic wave 1008 may interact with first formation feature 1002, a second formation feature 1004, and/or a third formation feature 1006 to form one or more response signals. The one or more response signals may be sensed and/or measured by one or more receiver subs 410, 411, and 412.

FIG. 10B illustrates measurements taken at first depth 1010 using the methods and systems described above. After taken measurements at first depth 1010, logging tool 126 may traverse to a second location 1012 and the measurement operations described above may be performed again. The distance between measurement at first depth 1010 and second depth 1012 may be about a foot, about five feet, about ten feet, about twelve feet, about twenty-five feet, about thirty feet, about forty feet, or about fifty feet. As illustrated, measurements may be taken at third depth 1014, fourth depth 1016, fifth depth 1018, and sixth depth 1020. However, it should be noted that measurements may be taken at any number of depths during LWD and/or MWD wellbore operating environment 100 (e.g., referring to FIG. 1) or conveyance logging operations 300 (e.g., referring to FIG. 3). It should be noted, at sixth depth 1020 an abnormal formation feature 1022 may be measured. Measurements taken at each depth may only measure a “window” of various subterranean formation 118 that may be about perpendicular to transmitter sub 405. This “window” may be a chosen distance, such as five feet and may be taken at each depth. However, each “window” may not be connected to each other as there may be a distance between each depth, as discussed above. Each of these “windows” may be combined, discussed below, to form an overall picture first formation feature 1002, a second formation feature 1004, and/or a third formation feature 1006 within subterranean formation 118.

FIG. 10C illustrates an example of a “sliding window.” In this example, the measurements at first depth 1010 and second depth 1012 may overlap with each other. Thus, the distance between first depth 1010 and second depth 1012 may be small enough that the “window” measured at each depth at least partially overlaps. Thus, as each measurement is taken, first window 1010 may expand with each subsequent measurement window, causing the first window 1010 to slide and expand with second window 1012. This may be performed for successive windows at each depth, for example as illustrated, third depth 1014, fourth depth 1016, fifth depth 1018, and sixth depth 1020. Thus, abnormal formation feature 1022 may be measured and added to sliding window 1020. The measurements taken at each depth, as described above, may be further utilized in an inversion workflow to identify resistivity variation within subterranean formation 118.

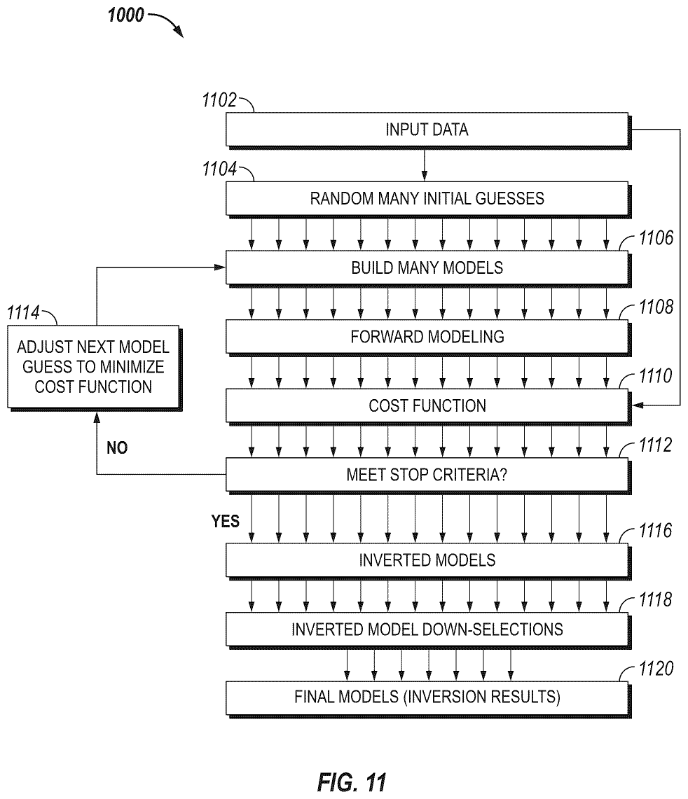

FIG. 11 illustrates inversion workflow 1100 for a many-initial-guess approach, combining a random statistical concept with a deterministic inversion algorithm. Inversion algorithms may be one-dimensional, two-dimensional, or three-dimensional. It should be noted that inversion workflow 1100 may at least partially be performed on information handling system 134. Inversion workflow 1100 may begin with block 1102. In block 1102, input data is selected one or more receiver subs 410, 411, and 412 (e.g., referring to FIG. 4). The input data may comprise one or more measurements taken at one or more depth, described above. The input data from block 1102 may be utilized in block 1104 to form one or more random initial guesses of formation resistivity and geological models surrounding a borehole 1024 within subterranean formation 118.

In block 1106 a random initial model pool comprising one or more random initial models may be produced. In examples, a random initial model pool may be produced from one or more random initial guesses from block 1104, utilizing statistical concepts. Statistical concepts applied in block 1106 may be central tendency, probability distribution, descriptive statistics, hypothesis testing, population, regression, sampling, probability, and/or the like. This may allow for the exploration of a wide range of possible model combinations, with each selected initial model from the pool being an input to the deterministic inversion algorithm. Each of the random initial models from block 1106 may be tested as a forward model in block 1108. Inputs to the forward modeling of block 1108 may comprise inputted formation geological models, resistivity profiles of the inputted formation geological models, analytical or numerical calculations to simulate tool responses for a given operating frequency and a given spacing between a transmitter antenna and a receiver antenna, and/or operating frequency. The product of block 1108 may be an updated geological model pool comprising one or more updated geological models. Further, the one or more geological models may be tool modeling responses of an operating frequency and transmitter-to-receiver spacing in a specific inputted formation model. In block 1110, the tool modeling responses from block 1108 may be utilized in a cost function. In examples, the cost function may calculate a misfit between a model response and an actual tool measurement acquired at a specific location downhole from block 1102. In examples, the input data from block 1102 may be utilized to perform the cost function on different simulated modeling responses of various geological models from the forward modeling. Further, the cost function may utilize a least squares calculation.

In block 1112, stop criterion is reviewed to determine if one or more selected models from block 1106 meets the stop criterion. Herein, the stop criterion may be a minimum threshold. Herein, the stop criterion If the misfit from block 1110 is greater than the stop criterion, then inversion workflow 1100 may proceed to block 1116. If, however, the misfit from block 1110 is equal to or less than the stop criterion, then inversion workflow 1100 may proceed to block 1114. In block 1114, a new random initial model pool may be created and blocks 1106-1112 are repeated until the stop criterion is satisfied. If there are many local minimum solutions or solution ambiguities, the inversion may utilize many iterations to attain a correct solution. This process is a Gauss-Newton minimization process, which iteratively identifies the best misfit model from each selected initial-guess model.

In block 1116 an inversion may be performed on the accepted modeling responses. The deterministic inversion may define an inverted model corresponding to a selected initial model. Since block 1104 forms one or more initial models, many inverted models may be produced in block 1116 from the inversion process. In block 1118, a second round of model down-selections removes incorrect solutions from an inverted model from block 1116. In examples, the second round of inversions may be based on another misfit threshold and isolates the best inverted models for the final answer product. Using the information form block 1118 a final model or models may be selected in block 1120 to correspond to the originally selected model. In other examples, an average model may be created from all the solutions/models found in block 1118. Multiple sets of inversion solutions may be provided in block 1120. Additionally, a final model, models, or an averaged model may identify resistivity variations for any abnormal formation features ahead of bit 114 (e.g., referring to FIG. 1), such as a possible fault formation, to be discussed below. Generally, if there is only one global solution, and if a robust inversion is used, the inverted solution should be independent of the selected initial-guess model. In some examples, a smoothing methodology referred to as “enhanced structure image,” (or “ESI”), may be applied to the solution to smooth out any discontinuities and form a smoothed solution. In further examples, ESI may be utilized to reinforce the horizontal continuity of the inversion interpretation. For example, an inversion interpretation which incorporates ESI may appear smoother than an inversion without ESI, which would appear more pixelated. Comparing the inversion result with and without ESI may highlight outliers that exist between the two interpretations which may further help with identifying potential faults and/or fractures. In some examples, the inversion results created in any of the foregoing methodologies may be rendered as a 2-dimensional or 3-dimensional inversion to identify potential faults and/or fractures. The selected model may be utilized with measurements taken during a measurement operation to determine resistivity profile of a borehole.

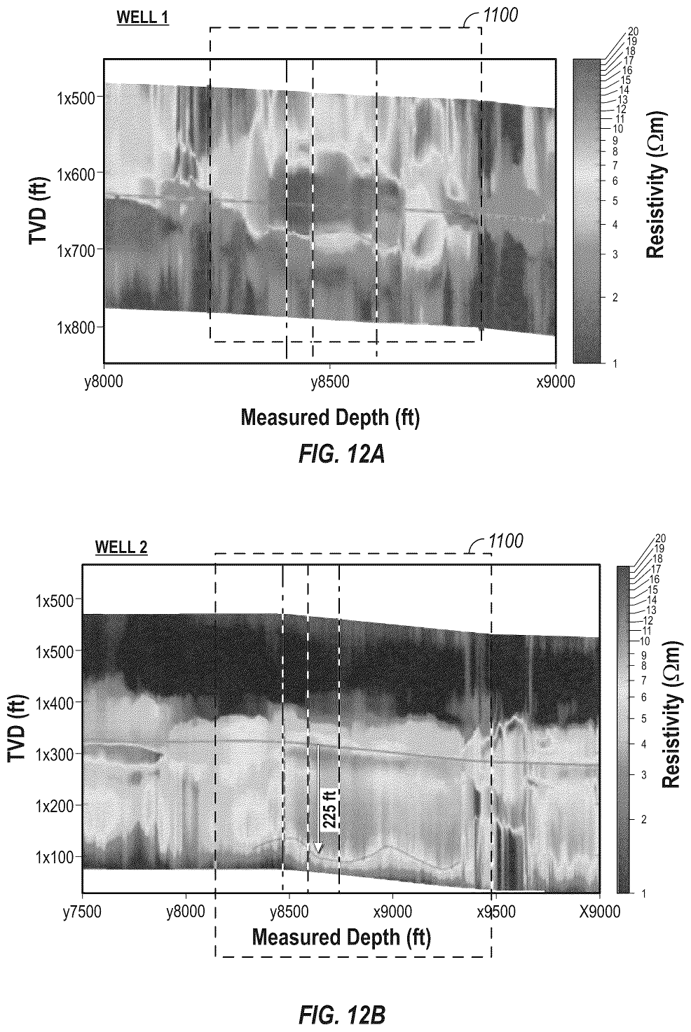

FIG. 12A illustrates a resistivity profile of an inversion solution determined in block 1120 (e.g., referring to FIG. 11) of Well 1. Even with identifying one or more models from workflow 1100, it may be challenging to confirm an actual depth of investigation (DOI) from tool measurements or from synthetic modeling responses because it varies with respect to tool parameters (such as spacing, frequency, and antenna orientation, tool and operational conditions, including SNR, vibration an temperature), and the properties and complexity of the formation. Using field test and field measurements, DOI was verified experimentally by running the ultra-deep resistivity tool in two wellbores whose vertical separation was of the order of the expected DOI.

The inversion results and formation evaluation data from the first well identified complex geology and distribution of fluids, arising from production and injection near the well. This fluid distribution had resulted in a distinctive reservoir structure, with boundaries marked by strong resistivity contrasts. The central part of the first well may comprise a very distinctive, high-resistivity zone, with strong contrasts above and below marking formation boundaries, and to the left and right as a result of faults. As illustrated in FIG. 12A, the lower boundary of the high-resistivity zone observed in Well 1 also shows a strong resistivity contrast. Gradient variations of the resistivity variations found may be utilized to determine changes in formation direction, faults, abnormal formation features, and/or the like.

Gradient variations work by tracking a formation feature through the resistivity profile. For example, as discussed above, at each depth measurements are taken. These measurements are utilized in workflow 1100 to create a resistivity profile of subterranean formation 118 at the depth in which the measurements may be taken. As measurements may be taken at additional depths, the resistivity profile, as seen in FIGS. 12A and 12B, is formed. Gradient variations measure the change in a resistivity profile of a formation feature at each depth in which measurements are taken. The gradient change, if there is any, is determined by locating the formation feature at a first depth in space, by its resistivity profile, and then finding the same formation feature in space at a second depth. The change between the first depth and second depth of the formation feature is the gradient variation. No change in gradient variation may show that the formation feature is not changing in direction or distance from logging tools 126. A slight change in gradient variation may show that the formation feature is moving away or toward logging tools 126. Large changes in gradient variation may show that a fault is present or an abnormal formation feature 1022 (e.g., referring to FIG. 10B), such as water, may be present. Gradient variations may be mathematically calculated using a specific distribution from an average model, a peak model, or a specific percentile model. When utilizing an average model solution from block 1120 at any selected depth may be compared to the average model to detect the one or more resistivity variations. In other examples, comparing solutions from each depth to each other using an individual distribution of the distributions may be utilized to determine one or more resistivity variations. In this example, only the top 5^{th} percentile of solutions may be used to detect resistivity variations.

FIG. 12B illustrates a distribution of an inversion solution determined in block 1120 (e.g., referring to FIG. 11) of Well 2. For the second well, it was determined that to detect the top boundary of the distinctive zone observed in the first well, an inversion in the range of 125 to 150 ft would be utilized. To achieve the needed DOI, the spacing between the transmitter coil 406 and a receiver coil 421 (e.g., referring to FIG. 4) was increased. DOI is a function of the transmitter-to-receiver spacing, as well as the transmission frequency and the resistivity of the surrounding formation. An increase in spacing should increase the DOI if the SNR is still sufficiently high. The far spacing was set to approximately 100 ft in the first well, increasing to 133 ft in the second.

Multiple iterations of the inversion from a model or models chosen in inversion workflow 1100 (e.g., referring to FIG. 11) in the second well, with increasing inversion depths, shed light on the DOI of wellbore tool 400 (e.g., referring to FIG. 4). The inversion depth is distinct from the DOI, and simply defines the maximum radius from the wellbore within which the inversion will calculate a result. An initial inversion to 150 ft clearly resolved the sharp resistivity boundary above Well 1, in the same spatial position. In FIG. 12B, extending the inversion depth in Well 2 to more than 200 ft also revealed this boundary very near the position observed in Well 1.

A comparison of the two sets of inversion, FIGS. 12A and 12B, results may provide a high degree of confidence in the depth of investigation of wellbore tool 400 because of the distinctive shape of the reservoir, which is visible in both sets of results and highlighted by area 1200. Additionally, the comparison may yield resistivity variations for any abnormal formation features ahead of the bit, such as a possible fault formation. An examination of the two sets of results yields additional features that are common to both, further reinforcing the correlation. Additional features may identify resistivity variations for any abnormal formation features ahead of the bit, such as a possible fault formation.

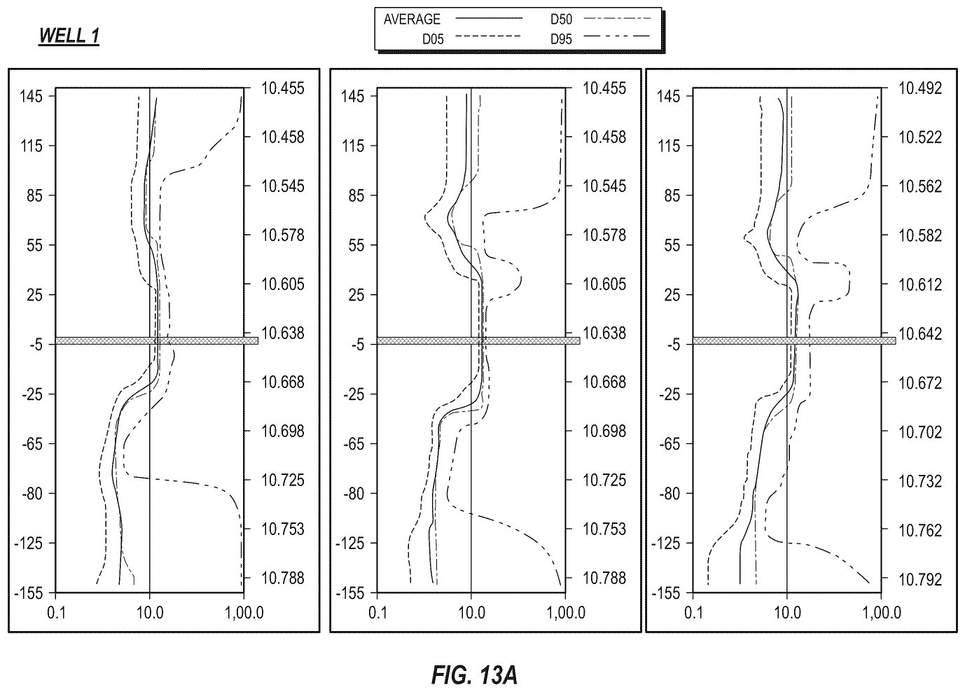

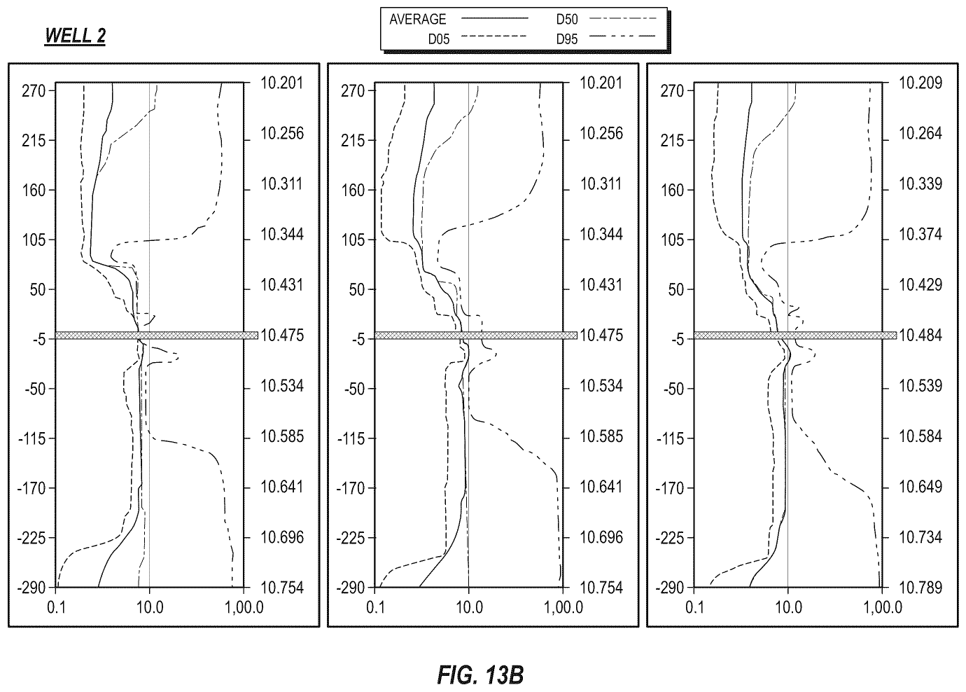

FIGS. 13A and 13B illustrate graphs showing changes in gradient variation for models found in block 1120 (e.g., referring to FIG. 10) for Well 1 and Well 2. Specifically, an average model, D05 model, D50 model, and D95 model are chosen to track the gradient variations. As shown in the graph, the models produce varying degrees of gradient variation at different depths, depending on the model. However, each of the models do have similar gradient variation for solutions at certain depths.

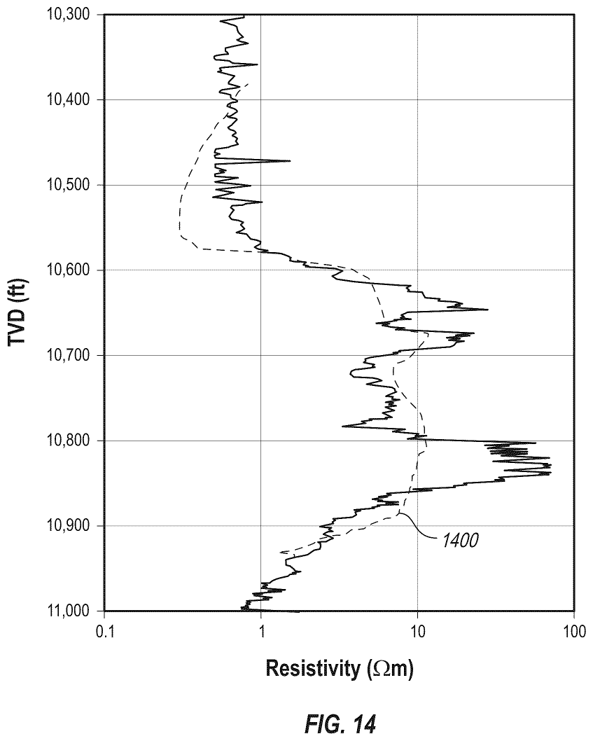

FIG. 14 is a graph showing a vertical resistivity profile from the inversion 1400 superimposed on data from a nearby well. The morphology of the resistivity curves is very similar. There are some differences between the two curves, which are probably attributable to the lateral separation of the offset and target wells, but their similarities support the conclusion that wellbore tool 400 detected an actual boundary of more than 200 ft away.

The methods and systems described above are improvements over current technology. Specifically, identifying gradient variations of formations and formation features respective to logging tools. By identifying the gradient variations using models, then the formations and formation features may be predicted as to their location in front of logging tools during drilling operations.

Statement 1: A method may comprise inserting an electromagnetic tool into a wellbore, wherein the wellbore traverses through a subterranean formation. The electromagnetic tool may comprise a transmitter sub comprising a transmitter coil and a first receiver sub comprising a first receiver coil. The method may further comprise transmitting an electromagnetic wave into the subterranean formation with the transmitter coil at a first depth, receiving a first collection of one or more response signals with the first receiver coil at the first depth, wherein the first collection of one or more responses signals are formed from the electromagnetic wave interacting with the subterranean formation, moving the electromagnetic tool to a second depth within the wellbore, transmitting a second electromagnetic wave into the subterranean formation with the transmitter coil at the second depth, and receiving a second collection of one or more response signals with the first receiver coil at the second depth, wherein the second collection of one or more responses signals are formed from the electromagnetic wave interacting with the subterranean formation. The method may further comprise forming a plurality of geological models based at least in part on the first collection of one or more responses signals and the second collection of one or more responses signals, inverting each of the plurality of geological models to form a solution for each of the plurality of geological models at the first depth and the second depth, and comparing each of the solutions for the first depth and the second depth to identify one or more resistivity variations within the subterranean formation.

Statement 2. The method of statement 1, wherein the one or more resistivity variations are identified by one or more gradient variations at the first depth or the second depth.

Statement 3. The method of statement 2, wherein the one or more gradient variations are of a specific distribution from an average model, a peak model, or a specific percentile of the solutions.

Statement 4. The method of any previous statements 1 or 2, further comprising creating an average model from each of the solutions for each of the plurality of geological models.

Statement 5. The method of statement 4, further comprising comparing the average model to each of the solutions at the first depth and the second depth to detect the one or more resistivity variations.

Statement 6. The method of statement 5, wherein the one or more resistivity variations indicate one or more faults ahead of the electromagnetic tool.

Statement 7. The method of any previous statements 1, 2, or 4, wherein the comparing each of the solutions for the first depth and the second depth utilizes an individual distribution of the solutions.

Statement 8. The method of statement 7, wherein only a top 5^{th} percentile of the solutions are used to detect the one or more resistivity variations.

Statement 9. The method of any previous statement 1, 2, 4, or 7, wherein the comparing each of the solutions for the first depth and the second depth utilizes a peak model for a distribution of the solutions.

Statement 10. The method of any previous statements 1, 2, 4, 7 or 9, wherein inverting utilizes a one-dimensional inversion algorithm, a two-dimensional inversion algorithm, or a three-dimensional inversion algorithm.

Statement 11. The method of any previous statements 1, 2, 4, 7, 9, or 10, wherein the transmitter sub is closer to a drill bit than the receiver sub.

Statement 12. The method of any previous statements 1, 2, 4, 7, or 9-10, further comprising applying an ESI to each of the solutions to form a smoothed solution for each of the solutions.

Statement 13. The method of statement 12, further comprising comparing each of the smoothed solutions to each of the solutions to detect one or more resistivity variations.

Statement 14. A system may comprise an electromagnetic tool which may comprise a transmitter sub comprising a transmitter coil for transmitting an electromagnetic wave into a subterranean formation with the transmitter coil at one or more depths and a first receiver sub comprising a first receiver coil for receiving one or more response signals at a plurality of depths. The system may further comprise an information handling system in communication with the electromagnetic tool and configured to form a plurality of geological models based at least in part on the one or more responses signals from the plurality of depths, invert each of the plurality of geological models to form a solution for each of the plurality of geological models at the plurality of depths, and compare each of the solutions for each of the plurality of depths to identify one or more resistivity variations within the subterranean formation.

Statement 15. The system of statement 14, wherein the one or more resistivity variations are identified by one or more gradient variations at the plurality of depths.

Statement 16. The system of statement 15, wherein the one or more gradient variations are of a specific distribution from an average model, a peak model, or a specific percentile of the solutions.

Statement 17. The system of any previous statements 14 or 15, wherein the information handling system is further configured to create an average model from each of the solutions for each of the plurality of geological models.

Statement 18. The system of statement 17, wherein the information handling system is further configured to compare the average model to each of the solutions at the plurality of depths to detect the one or more resistivity variations.

Statement 19. The system of statement 18, wherein the one or more resistivity variations indicate one or more faults ahead of the electromagnetic tool.

Statement 20. The system of any previous statements 14, 15, or 17, wherein the compare each of the solutions for the plurality of depths utilizes an individual distribution of the solutions.

The preceding description provides various examples of the wellbore tools and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

What is claimed is:

1. A method comprising:
inserting an electromagnetic tool into a wellbore, wherein the wellbore traverses through a subterranean formation and wherein the electromagnetic tool comprises:
a transmitter sub comprising a transmitter coil;
a first receiver sub comprising a first receiver coil;
transmitting an electromagnetic wave into the subterranean formation with the transmitter coil at a first depth;
receiving a first collection of one or more response signals with the first receiver coil at the first depth, wherein the first collection of one or more responses signals are formed from the electromagnetic wave interacting with the subterranean formation;
moving the electromagnetic tool to a second depth within the wellbore;
transmitting a second electromagnetic wave into the subterranean formation with the transmitter coil at the second depth;
receiving a second collection of one or more response signals with the first receiver coil at the second depth, wherein the second collection of one or more responses signals are formed from the electromagnetic wave interacting with the subterranean formation;
forming a plurality of geological models based at least in part on the first collection of one or more responses signals and the second collection of one or more responses signals;
inverting each of the plurality of geological models to form a solution for each of the plurality of geological models at the first depth and the second depth; and
comparing each of the solutions for the first depth and the second depth to identify one or more resistivity variations within the subterranean formation.

2. The method of claim 1, wherein the one or more resistivity variations are identified by one or more gradient variations at the first depth or the second depth.

3. The method of claim 2, wherein the one or more gradient variations are of a specific distribution from an average model, a peak model, or a specific percentile of the solutions.

4. The method of claim 1, further comprising creating an average model from each of the solutions for each of the plurality of geological models.

5. The method of claim 4, further comprising comparing the average model to each of the solutions at the first depth and the second depth to detect the one or more resistivity variations.

6. The method of claim 5, wherein the one or more resistivity variations indicate one or more faults ahead of the electromagnetic tool.

7. The method of claim 1, wherein the comparing each of the solutions for the first depth and the second depth utilizes an individual distribution of the solutions.

8. The method of claim 7, wherein only a top 5^{th} percentile of the solutions are used to detect the one or more resistivity variations.

9. The method of claim 1, wherein the comparing each of the solutions for the first depth and the second depth utilizes a peak model for a distribution of the solutions.

10. The method of claim 1, wherein inverting utilizes a one-dimensional inversion algorithm, a two-dimensional inversion algorithm, or a three-dimensional inversion algorithm.

11. The method of claim 1, wherein the transmitter sub is closer to a drill bit than the receiver sub.

12. The method of claim 1, further comprising applying an ESI to each of the solutions to form a smoothed solution for each of the solutions.

13. The method of claim 12, further comprising comparing each of the smoothed solutions to each of the solutions to detect one or more resistivity variations.

14. A system comprising:
an electromagnetic tool which comprises:
a transmitter sub comprising a transmitter coil for transmitting an electromagnetic wave into a subterranean formation with the transmitter coil at one or more depths;
a first receiver sub comprising a first receiver coil for receiving one or more response signals at a plurality of depths; and
an information handling system in communication with the electromagnetic tool and configured to:
form a plurality of geological models based at least in part on the one or more responses signals from the plurality of depths;
invert each of the plurality of geological models to form a solution for each of the plurality of geological models at the plurality of depths; and
compare each of the solutions for each of the plurality of depths to identify one or more resistivity variations within the subterranean formation.

15. The system of claim 14, wherein the one or more resistivity variations are identified by one or more gradient variations at the plurality of depths.

16. The system of claim 15, wherein the one or more gradient variations are of a specific distribution from an average model, a peak model, or a specific percentile of the solutions.

17. The system of claim 14, wherein the information handling system is further configured to create an average model from each of the solutions for each of the plurality of geological models.

18. The system of claim 17, wherein the information handling system is further configured to compare the average model to each of the solutions at the plurality of depths to detect the one or more resistivity variations.

19. The system of claim 18, wherein the one or more resistivity variations indicate one or more faults ahead of the electromagnetic tool.

20. The system of claim 14, wherein the compare each of the solutions for the plurality of depths utilizes an individual distribution of the solutions.
